(19) United States
(12) Patent Application Publication
(10) Pub. No.: US 2007/0076555 A1
(43) Pub. Date: Apr. 5, 2007

(54) OPTICAL DISK DEVICE AND METHOD FOR PLAYING OPTICAL DISK

(76) Inventor: Junichi Morimura, Sagamihara-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/536,203

(22) Filed: Sep. 28, 2006

(30) Foreign Application Priority Data
Sep. 30, 2005 (JP) 2005-288758

(51) Int. Cl. G11B 20/10

(52) U.S. Cl. 369/59.22

(57) ABSTRACT

An optical disk device includes pickup head for irradiating an optical disk with an optical beam and receiving a reflected beam from the optical disk to output an RF signal, first equalizing unit which boosts a frequency band of the RF signal from the pickup head, the frequency band corresponding to a minimum recording signal recorded on an optical disk, clock generating unit which generates a clock signal on the basis of the RF signal boosted by the first equalizing unit, second equalizing unit which equalizes the RF signal or the boosted RF signal to a partial response waveform signal on the basis of the clock signal generated by the clock generating unit and an equalization coefficient, and a decoding section which executes maximum likelihood decoding on the partial response waveform signal on the basis of the clock signal generated by the clock generating unit to output a reproduction signal.

### CROSS-REFERENCE TO RELATED APPLICATIONS

This application is based upon and claims the benefit of priority from prior Japanese Patent Application No. 2005-288758, filed Sep. 30, 2005, the entire contents of which are incorporated herein by reference.

### BACKGROUND OF THE INVENTION

1. Field of the Invention

The present invention relates to an optical disk device that uses a PLL circuit to reproduce signals from an optical disk with an increased density, and a method for playing an optical disk.

2. Description of the Related Art

With conventional optical disks, binarization based on level slicing is carried out depending on whether a reproduction signal level is higher or lower than a threshold. However, for high definition digital versatile discs (HD DVDs), their increased density tends to reduce the amplitude of reproduction signals. Consequently, the binarization based on level slicing is likely to result in frequent identification errors. Thus, HD DVDs (High Definition Digital Versatile Discs) employ partial response maximum likelihood (PRML) to binarize reproduction signals (Toshiba Review: Vol. 60, No. 1 (2005), P 25 to P 28, “Technique for Processing Reproduction Signals from HD DVDs”, Hiroshi KASHIWARA).

A reproduction signal processing block for HD DVD is shown in FIG. 1 of Toshiba Review: Vol. 60, No. 1 (2005), P 25 to P 28, “Technique for Processing Reproduction Signals from HD DVDs”, Hiroshi KASHIWARA. In this block, PRML is executed by an equalizer and a Viterbi decoder. An RF signal (reproduction signal) passes through the equalizer. The Viterbi decoder then modifies an actual waveform to an ideal one, which is then used as a reproduction signal. Before the circuit shown in FIG. 1 can operate normally, a PLL circuit dedicated for PRML must operate normally.

To execute a PRML process to reproduce signals from an optical disk with an increased density, it is necessary to stabilize PLL operations in order to allow PRML operate stably.

### BRIEF SUMMARY OF THE INVENTION

An aspect of the present invention provides an optical disk device comprises pickup head for irradiating an optical disk with an optical beam and receiving a reflected beam from the optical disk to output an RF signal, first equalizing unit which boosts a frequency band of the RF signal from the pickup head, the frequency band corresponding to a minimum recording signal recorded on an optical disk, clock generating unit which generates a clock signal on the basis of the RF signal boosted by the first equalizing unit, second equalizing unit which equalizes the RF signal or the boosted RF signal to a partial response waveform signal on the basis of the clock signal generated by the clock generating unit and an equalization coefficient, and a decoding section which executes maximum likelihood decoding on the partial response waveform signal on the basis of the clock signal generated by the clock generating unit to output a reproduction signal.

### BRIEF DESCRIPTION OF THE SEVERAL VIEWS OF THE DRAWING

FIG. 1 is a perspective view schematically showing the structure of an optical disk device in accordance with an embodiment of the present invention;

FIG. 2 is a block diagram showing the configuration of an optical pickup in the optical disk device shown in FIG. 1;

FIG. 3 is a diagram showing circuit blocks including a pickup shown in FIG. 2;

FIG. 4 is a block diagram showing a system that plays HD DVD;

FIGS. 5A and 5B are diagrams showing a 2T signal before and after boosting; and

FIG. 6 is a diagram showing a 3T signal for DVD media and a 2T signal for HD DVD media.

### DETAILED DESCRIPTION OF THE INVENTION

Description will be given of an optical disk device that can play HD DVD (High Definition Digital Versatile Disc) media and non-HD DVD media.

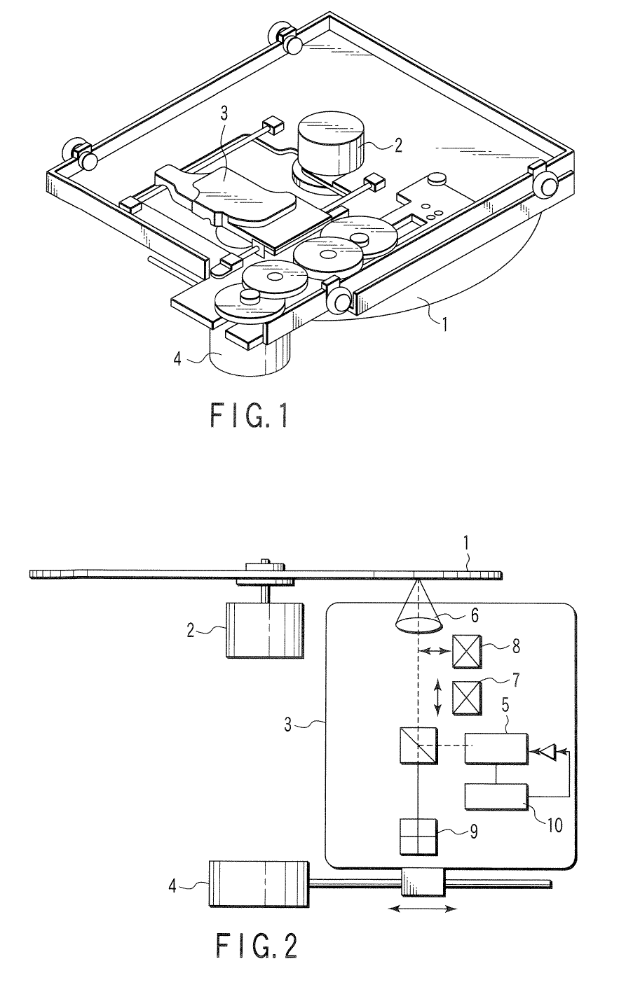

FIG. 1 is a diagram schematically showing the structure of an optical disk device in accordance with a first embodiment of the present invention. FIG. 2 is a block diagram showing the configuration of an optical pickup integrated into the optical disk device.

As shown in FIG. 1, the optical disk device in accordance with the present embodiment is mainly composed of a disk motor 2 that rotatively drives the disk 1, a pickup 3 that reads signals recorded on the disk 1, a feed motor 4 that moves the pickup 3 in a radial direction of the disk 1, and a main board on which a microcomputer, a signal processing circuit, and the like are mounted. The feed motor 4 is provided with sensor for sensing the rotational conditions of the motor such as the rotating frequency, speed, and rotating direction of the motor. A feed motor driving signal circuit uses an output signal from the sensing signal to control the feed motor 4 during track search.

As shown in FIG. 2, the pickup 3 is mainly provided with light emitting diode 5 that outputs a laser beam, an objective lens 6 supported by a wire or blade spring (not shown) and which focuses the laser beam emitted by the light emitting diode 5 on a surface of the disk 1, which is thus irradiated with the laser beam, a focusing coil 7 and a tracking coil 8 which controllably moves the objective lens 6 in a focus direction and a tracking direction, respectively, a photodetector 9 that receives the reflected beam from the disk 1, and a monitor detector 10 which monitors the reflected beam from the disk 1 and which feeds back data to the light emitting diode 5.

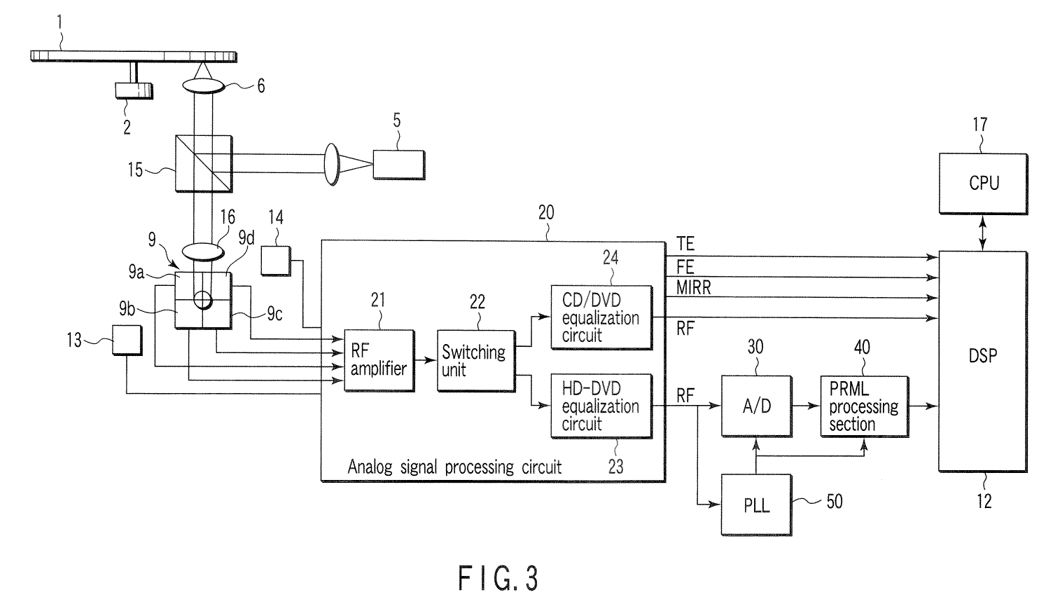

FIG. 3 is a diagram showing circuit blocks including the pickup 3. The circuit has an analog signal processing section 20 to which a signal read by the pickup 3 is supplied and DSP (Digital Signal Processor) 12 to which a signal amplified by the analog signal processing section 20 is supplied.

As shown in FIG. 3, the pickup 3, connected to the analog signal processing section 20, has a 4-divided photodetector 9 and sub-beam detectors 13 and 14 that create track error signals for CD. The pickup 3 further has a light emitting diode 5 that emits a laser beam with which the optical disk 1 is irradiated, a splitter 15 that separates the generated laser beam from the reflected beam from the optical disk 1, the objective lens 6, and a condensing lens 16 placed in front of the 4-divided photodetector 9.

The optical disk 1 is irradiated, via the splitter 15 and objective lens 6, with an optical beam emitted by the light emitting diode 5. A reflected beam from the optical disk 1 is guided to the 4-divided photodetector 9 via the objective lens 6, splitter 15, and condensing lens 16.

The 4-divided photodetector 9 consists of a four-piece light receiving element including photo-detecting cells 9a, 9b, 9c, and 9d.

Outputs from the photo-detecting cells 9a, 9b, 9c, and 9d and sub-beam detectors 13 and 14 are input to the analog signal processing section 20. The analog signal processing section 20 then amplifies and subjects the signals to an addition and a subtraction to output a tacking error signal (TE), a focus error signal (FE), an RF signal, and a MIRR signal.

The tracking error (TE) signal and focus error (FE) signal are servo signals from the optical disk 1 which are used to perform servo operations of tracking and focusing the objective lens 6. The RF signal is a read reproduction data signal. The MIRR signal indicates the envelope of the RF signal.

An RF amplifier 21 adds together and amplifies output signals from the photo-detecting cells 9a, 9b, 9c, and 9d of the photodetector 9 to output an RF signal.

That is, when the outputs from the photo-detecting cells 9a, 9b, 9c, and 9d are defined as A, B, C, and D, the RF amplifier 21 uses a signal RF=A+B+C+D to generate a high frequency signal RF.

Similarly, the analog signal processing section 20 uses a signal FE=(A+C)−(B+D) to generate a focus error signal FE. The RF amplifier 20 also uses a signal TE=(A+B)−(C+D) to generate a tracking error signal TE.

The MIRR signal is produced by sensing the peak and bottom of the RF waveform to execute the calculation {(peak)−(bottom)}. When a lens jump occurs, that is, when the driving coil 11 is used to move the objective lens 6 a distance corresponding to a plurality of tracks in the tracking direction, the MIRR signal is used to check the actual number of tracks corresponding to the distance the lens has moved.

The track error (TE) signal for CD playing is produced by calculating the difference (E−F) between an output current E from the sub-beam detector 13 and an output current F from the sub-beam detector 14.

DSP 12 is connected to CPU 17 and operates on the basis of instructions from CPU 17.

Now, adjustment of RF amplitude will be described. RF amplitude adjustment in optical disk equipment is intended to achieve a target RF amplitude value on the basis of the MIRR signal. Specifically, an A/D converter in DSP 12 reads the current MIRR signal level and compares it with a preset target value. On the basis of the comparison, the A/D converter then adjusts the RF amplitude of the RF amplifier 20.

An RF signal amplified by the RF amplifier 20 is supplied via a switching unit 22 to an HD DVD equalization circuit 23 corresponding to HD DVD media or a CD/DVD equalization circuit 24 corresponding to CD media and DVD media. When an optical disk is inserted into the device and the media is then determined, the switching unit 22 determines to which of the equalization circuits 23 or 24 the signal is supplied.

The CD/DVD equalization circuit 24 optimizes boost amount and the like so as to, for example, minimize the level of jitter or to optimize the slice level of the RF signal. In other words, the boost amount and the like are set so as to maximize read rate.

If the media is HD DVD, the HD DVD equalization circuit 23 processes the RF signal so as to ensure the operation of the PLL circuit 50. The processed RF signal is supplied to the PLL circuit 50 and A/D converter 30. The A/D converter 30 digitally converts the signal and supplies the resultant signal to a PRML processing section 40. The PRML processing section 40 executes a PRML process on the signal and supplies the resultant signal to DSP 12.

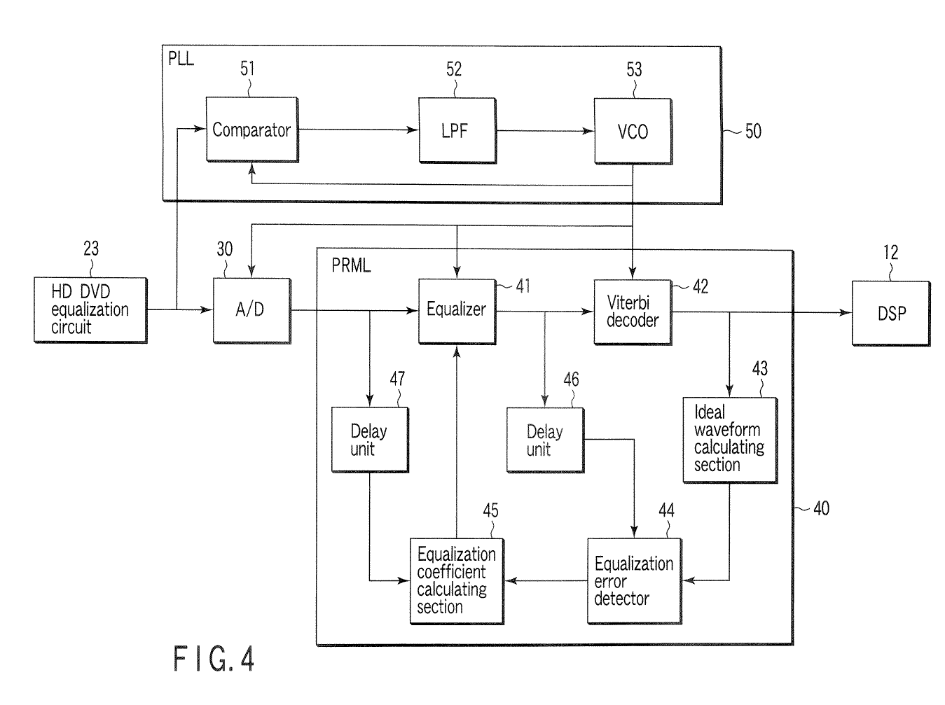

The configurations of the PLL circuit and PRML processing section will be described with reference to FIG. 4.

In the PLL circuit 50, the RF signal is input to a phase comparator 51. The phase comparator 51 compares the RF signal with a comparison signal output by a voltage control oscillator (VCO) 53. The phase comparator 51 then outputs a phase difference component as a pulse-like phase difference signal. The phase difference signal has its high frequency component blocked by a loop filter (integration circuit/low pass filter) 52. The phase difference signal is thus converted into a DC signal, which is then input to the voltage control oscillator 53. The voltage control oscillator 53 has a specified free-running frequency to vary oscillation frequency depending on the phase difference signal. On the basis of the input signal, the voltage control oscillator 53 adjusts the oscillation frequency to output a clock signal. The clock signal is supplied to the phase comparator 51; the clock signal corresponds to a comparison signal. The clock signal output by the voltage control oscillator 53 is supplied to the A/D converter 30 and PRML processing section 40.

The RF signal supplied by the HD DVD equalization circuit 23 is digitally converted by the A/D converter 30. The RF signal is then supplied to the equalizer 41 and a delay unit 47 in the PRML processing section 40. On the basis of an equalization coefficient calculated by an equalization coefficient calculating section 45, the equalizer 41 equalizes the RF signal to obtain a partial response waveform. Here, the target partial response waveform is a PR value (1, 2, 2, 2, 1) or (3, 4, 4, 3). The PR value may have another pattern. The equalizer is driven by a clock signal supplied by the PLL circuit 50.

The signal equalized by the equalizer 41 is supplied to a Viterbi decoder 42 and a delay unit 46. The Viterbi decoder 42 is driven by the clock signal supplied by the PLL circuit 50. The Viterbi decoder 42 executes maximum likelihood decoding on the partial response waveform to obtain a reproduction signal. The Viterbi decoder 42 then supplies the reproduction signal to DSP 12 and an ideal waveform calculating section 43. The ideal waveform calculating section 43 converts the reproduction signal into an ideal waveform. The ideal waveform obtained is supplied to an equalization error detector 44.

The equalization error detector 44 compares the partial response waveform supplied via the delay unit 46 with an ideal waveform to detect an equalization error. The detected equalization error is supplied to the equalization coefficient calculating section 45. The delay unit 46 adjusts the partial response waveform and the ideal waveform supplied by the ideal waveform calculating section 43 so that the waveforms are input to the equalization error detector 44 at the same time.

The equalization coefficient calculating section 45 calculates an equalization coefficient from the equalization error generated by the equalization error detector 44 and a signal supplied by the A/D converter 30 via the delay unit 47. The equalization coefficient calculating section 45 supplies the calculated equalization coefficient to the equalizer 41.

To operate the PRML processing section 40, it is essential to allow the PLL circuit 50 to operate stably. To allow the PLL circuit 50 to operate stably, signals including minimum signals 2T, which is not present in DVD, must be reliably used as PLL lock signals. The 2T signals account for about 30 percents of all the signals. Accordingly, 2T signal detecting performance relates greatly to reproducing performance. The RF signal equalization circuit is conventionally adjusted mainly to improve the capability of reproducing RF signals. However, the present device adjusts the HD DVD equalization circuit 23 taking into account improvement of PLL lock performance.

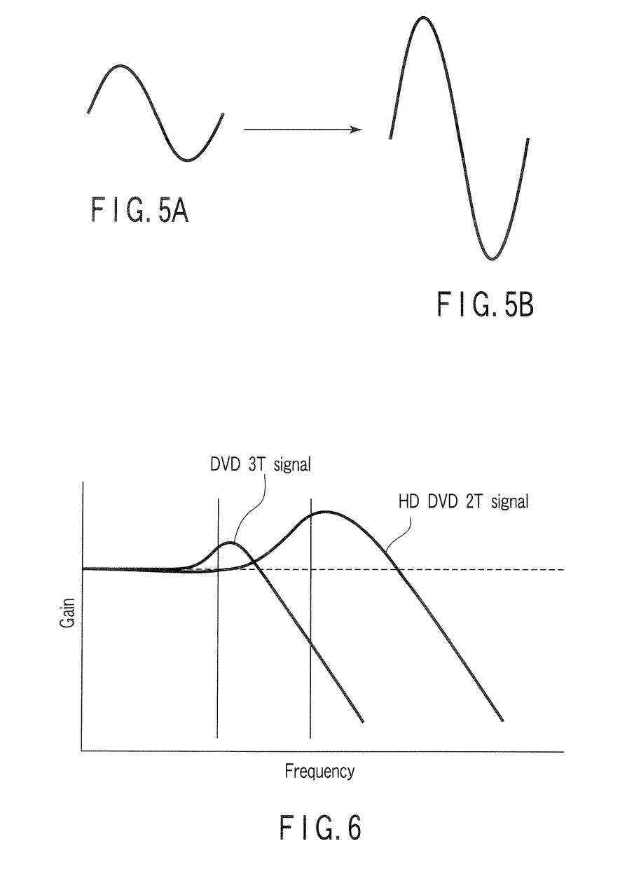

A clock signal supplied by the PLL circuit 50 is required for the PRML processing circuit 40 to execute a PRML process. All the signals including the minimum signals 2T are required for the PLL circuit 50 to lock PLL. Thus, to lock stable PLL, the HD DVD equalization circuit 23 executes a process of boosting the minimum signal (2T signal). By boosting the 2T signal shown in FIG. 5(a), it is possible to amplify the signal amplitude of the 2T signal to improve the PLL lock performance as shown in FIG. 5(b).

Specifically, boost setting is carried out as shown in FIG. 6. Normally, a boost amount of about 3 dB is specified for DVD, and a boost amount of about 6 dB is specified for HD DVD. However, experiments indicate that, for HD DVD, a boost amount of at least 12 dB and at most 24 dB is required to obtain sufficient PLL lock performance. This is partly due to degradation of actual signals. Experiments indicate that, owing to its high frequency, the 2T signal component may become smaller than it originally is if the optical band of the pickup is insufficient. Moreover, various signal degradation factors are present in a signal transmission path. The transmission path itself may function as a low pass filter. In this case, the 2T signal, having a high frequency, has its signal amplitude reduced below its original value. Thus, to operate the PLL circuit 50 stably, it is essential to boost the 2T signal.

The 2T signal is thus boosted in order to allow the PLL circuit 50 to operate stably. Accordingly, in the above embodiment, the boosted RF signal is supplied to the PRML processing section 40 as well as the PLL circuit 50, but the following is also possible. The boosted RF signal may be supplied to the PLL circuit 50, whereas a non-boosted RF signal may be supplied to the PRML processing section 40.

As described above, to play HD DVD, the minimum signal (2T signal) is selectively boosted to allow the PLL circuit 50 to operate stably. This allows a clock signal to be stably supplied to the PRML processing section 40. As a result, the PRML processing section 40 operates stably to suppress the occurrence of errors.

Even if the PRML technique is used for a reproduction system for DVD media, amplifying minimum signals (3T signals) for DVD allows the PLL circuit 50 to operate stably. This also allows the PRML processing section 40 to operate stably to suppress the occurrence of errors.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk device comprising:
pickup head for irradiating an optical disk with an optical beam and receiving a reflected beam from the optical disk to output an RF signal;
first equalizing unit which boosts a frequency band of the RF signal from the pickup head, the frequency band corresponding to a minimum recording signal recorded on an optical disk;
clock generating unit which generates a clock signal on the basis of the RF signal boosted by the first equalizing unit;
second equalizing unit which equalizes the RF signal or the boosted RF signal to a partial response waveform signal on the basis of the clock signal generated by the clock generating unit and an equalization coefficient; and
a decoding section which executes maximum likelihood decoding on the partial response waveform signal on the basis of the clock signal generated by the clock generating unit to output a reproduction signal.

2. The optical disk device according to claim 1, wherein a partial response value (1, 2, 2, 2, 1) or (3, 4, 4, 3) is used as the partial response waveform.

3. The optical disk device according to claim 1, wherein the minimum recording signal is a 2T signal, and the amount of boosting carried out by the first equalizing means is at least 12 dB and at most 24 dB.

4. A method for playing an optical disk comprising:
irradiating an optical disk with an optical beam and receiving a reflected beam from the optical disk to output an RF signal;
boosting a frequency band of the RF signal, the frequency band corresponding to a minimum recording signal recorded on an optical disk;
generating a clock signal from the boosted RF signal boosted by the first equalizing means;
equalizing the RF signal or the boosted RF signal to a partial response waveform signal on the basis of the generated clock signal; and
executing maximum likelihood decoding on the partial response waveform signal on the basis of the generated clock signal to output a reproduction signal.

5. The method for playing an optical disk according to claim 4, wherein a partial response value (1, 2, 2, 2, 1) or (3, 4, 4, 3) is used as the partial response waveform.

6. The method for playing an optical disk according to claim 4, wherein the minimum recording signal is a 2T signal, and boost amount is at least 12 dB and at most 24 dB.
